(19) United States
(12) Patent Application Publication
(10) Pub. No.: US 2008/0022549 A1
(43) Pub. Date: Jan. 31, 2008

(54) Dryer

(76) Inventor: Shing-Hong Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/715,475

(22) Filed: Mar. 8, 2007

Related U.S. Application Data
(63) Continuation-in-part of application No. 11/494,906, filed on Jul. 31, 2006, now abandoned.

(51) Int. Cl. F26B 3/00

(52) U.S. Cl. 34/443

(57) ABSTRACT

A dryer includes a dryer body, a driving device, a groove, and an upper cover. The groove is located around the opening of the dryer body. The upper cover has a cone shape and is located at the opening of the dryer body. The edge of the bottom of the upper cover is located at the groove. The angle of the cone end of the upper cover makes the water drops condensed on the inner wall of the upper cover slide downward along the inner wall of the upper cover so that they are collected in the groove.

### CROSS REFERENCE TO RELATED APPLICATION

This application is a continuation-in-part of U.S. application Ser. No. 11/494,906, filed on 31 Jul. 2006 and entitled “A DRYER”, now pending.

### BACKGROUND OF THE INVENTION

1. Field of the Invention

The present invention relates to a dryer. In particular, this invention relates to a dryer that prevents drops of condensed water that form on the inner wall of the dryer from dropping onto the dried objects in the dryer.

2. Description of the Related Art

Dryers are used for vaporizing water in the object that is placed in the dryer. Therefore, the dryer generates large amounts of steam during the drying process.

Generally, the more sealed the space is, the faster the drying speed is. Because the sealed space doesn't release heat easily, the temperature in the inner part of the dryer rises rapidly and stays high. However, in the sealed space, when the steam contacts the inner wall of the dryer, the steam condenses on the inner wall and forms water drops. The water drops on the inner wall will drop onto the dried objects due to gravity. Therefore, the drying time becomes longer and the power is wasted.

The dryer of the prior art usually has a ventilating channel 11 (as shown in FIG. 1), or an external air drying machine 12 (as shown in FIG. 2). These devices are used to prevent the steam from remaining in the dryer, condensing in the inner wall, and dropping onto the dried objects. However, exhausting the high temperature steam makes drier air enter the dryer 1 and lower the temperature. Therefore, because it takes time to increase the temperature in the dryer 1, power is wasted and the temperature in the dryer 1 cannot be maintained at a high temperature. Furthermore, continuously exhausting the steam also exhausts the odor of the dried object. The unpleasant smell of the dried objects is decreased. Moreover, when the dried objects have a toxic or foul smell, the exhausted steam pollutes the environment.

### SUMMARY OF THE INVENTION

One particular aspect of the present invention is to provide a dryer. The dryer can exhaust water drops condensed on the inner wall to prevent the water drops from dropping onto dried objects, reduces required power, can be operated at a high temperature to achieve a disinfecting effect, and prevents poisonous air from polluting the environment.

Moreover, the dryer provides a heat insulating element for keeping its dryer body at a high temperature.

The dryer includes a dryer body having an upward opening, a driving device connected with the dryer body, a control device connected with the dryer body, a groove located around the upward opening of the dryer body, an upper cover, and a heat insulating element. The upper cover has a cone shape. The angle of the cone end is larger than 0 degrees and is less than or equal to 35 degrees. The upper cover is located at the opening of the dryer body. The edge of the bottom of the upper cover is located at the groove. The heat insulating element is disposed in the groove and is disposed between the dryer body and the upper cover for preventing heat transmitted from the dryer body to the upper cover.

When the dryer is operating, steam rises and condenses to water drops on the inner wall of the upper cover. The angle of the upper cover makes the water drops slide downward along the inner wall of the upper cover as to prevent the water drops from dropping onto the dried objects. The groove is used for collecting the condensed water drops and preventing the water drops from dropping onto the dried objects when the water drops slide downward along the inner wall of the upper cover.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the dryer having a ventilating channel of the prior art;

FIG. 2 is a schematic diagram of the dryer having an external air drying machine of the prior art;

FIG. 3 is a perspective view of the first embodiment of the present invention;

FIG. 3A is an amplified diagram of part A of FIG. 3;

FIG. 4 is a schematic diagram of the usage status of the first embodiment of the present invention;

FIG. 4A is an amplified diagram of part A of FIG. 4;

FIG. 5 is a schematic diagram of the usage status of the second embodiment of the present invention;

FIG. 5A is an amplified diagram of part A of FIG. 5; and

FIG. 6 is a schematic diagram of the usage status of the third embodiment of the present invention.

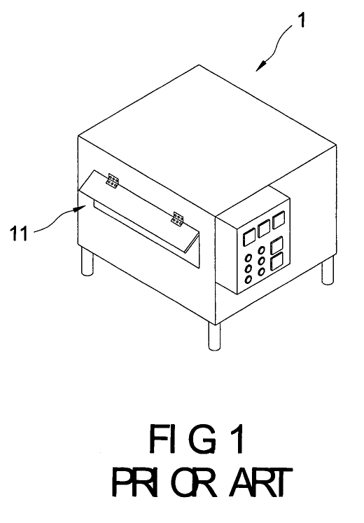

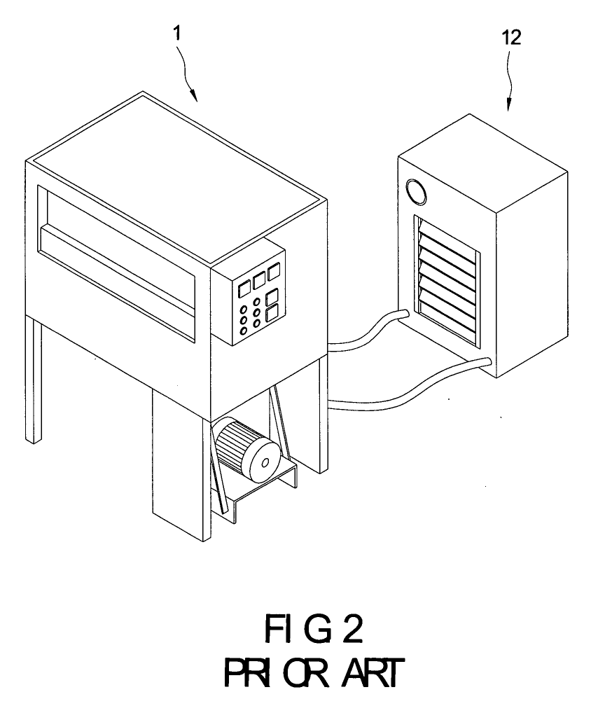

### DETAILED DESCRIPTION OF THE PREFERRED EMBODIMENTS

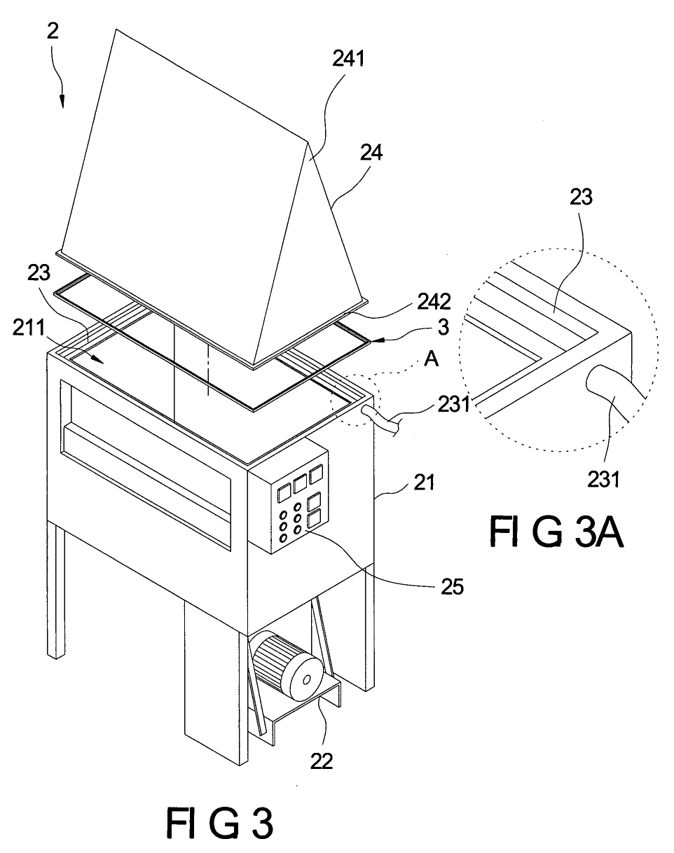

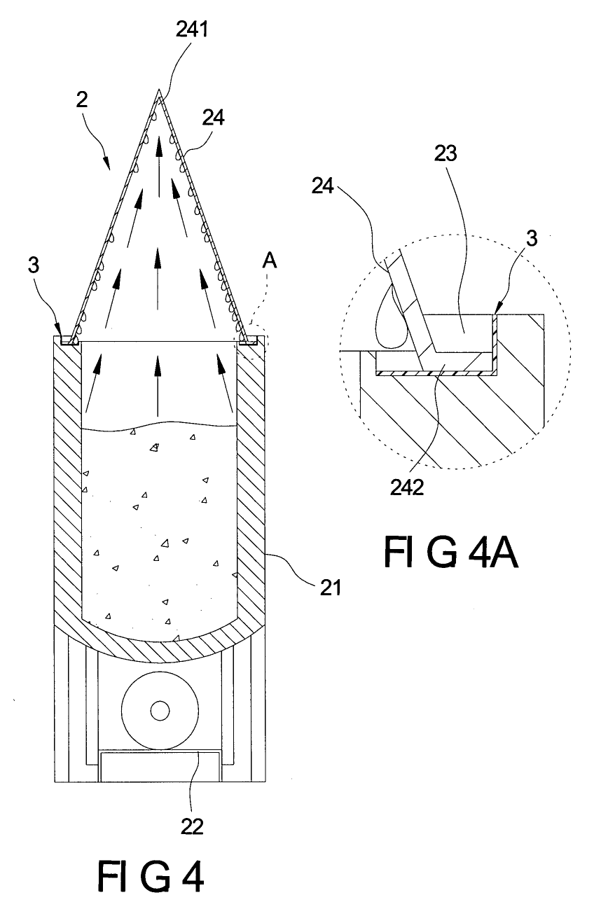

Reference is made to FIGS. 3˜4A. The dryer 2 includes a dryer body 21, a driving device 22, a groove 23, an upper cover 24, a control device 25, and a heat insulating element 3 disposed in the groove 23. The dryer body 21 has an upward opening 211. In the inner part of the dryer body 21, there is a heating device and a stirring device (not shown in the figure, the heating device and the stirring device are conventional devices). The driving device 22 is a motor, and is located under the dryer body 21 and is connected with the dryer body 21. The driving device 22 drives the stirring device to stir the object to make the object be dried uniformly. The control device 25 is used for turning on and turning off the driving device 22 and the heating device to control the dryer 2. The groove 23 is located around the opening 211 of the dryer body 21. An exhausting water pipe 231 is connected with the groove 23 for exhausting the water collected in the groove 23. The upper cover 24 is made of metal that is good for heat-exhausting, such as silver, copper, or aluminum. The upper cover 24 is located at the opening 211 of the dryer body 21 so as to make the inner part of the dryer body 21 sealed so as to increase the drying effect. Moreover, the heat insulating element 3 is disposed between the upper cover 24 and the dryer body 21 for insulating the heat transmitted form the dryer body 21 to the upper cover 24 in order to keep the dryer body 21 at a high temperature always. The upper cover 24 has a cone shape. The angle of the cone end 241 is larger than 0 degrees and is less than or equal to 35 degrees. The preferred angle is 30 degrees. When the dryer 2 is operating, steam condenses on the inner wall of the upper cover 24 to form water drops, and make the water drops slide downward along the inner wall of the upper cover 24 so as to prevent the water drops from dropping onto the dried objects. The edge 242 of the bottom of the upper cover 24 is located at the groove 23. Therefore, the water drops sliding along the upper cover 24 collect in the groove 23 to prevent the water drops from dropping onto the dried objects. The exhausting water pipe 231 connected with the groove 23 is used for exhausting the water collected in the groove 23.

When the dryer 2 is operating, the drying object generates steam. The steam rises and toughs the inner wall of the upper cover 24 to form water drops on the inner wall of the upper cover 24. The water drops slide along the inner wall of the upper cover 24 and drop into the groove 23 and are collected in the groove 23. Therefore, the drying process is executed in a sealed space and prevents the dried objects from being rewet. The drying time is shortened and the required power is decreased. Because the drying process is executed in a sealed space and the steam condenses on the inner wall of the upper cover 24, the dryer 2 is kept at a high temperature to achieve the disinfecting effect, and prevents poisonous air or the odor of the dried objects from exhausting out of the dryer 2 and polluting the environment.

The groove 23 can be integrated with the dryer body 21 into one piece, or is locked or welded with the opening 211 of the dryer body 21. The shape of the groove 23 corresponds to the shape of the opening 211 of the dryer body 21. For example, when the shape of the opening is quadrilateral, a pentagon, a circle, or an irregular-shape, the shape of the groove 23 is quadrilateral-frame shaped, pentagon-frame shaped, circle-frame shaped, or an irregular-frame shaped. Similarly, the shape of the edge 242 of the bottom of the upper cover 24 also corresponds to the shape of the opening 211 of the dryer body 21, such as a quadrilateral, a pentagon, a circle, or an irregular-shape. The upper cover 24 can be triangle column-shaped as shown in FIG. 3. Alternatively, the upper cover 24 also can be quadrilateral cone-shaped, pentagon cone-shaped, circle cone-shaped, or irregular-shape. The required condition for the upper cover 24 is that the angle of the cone end 1241 of the upper cover 24 is greater than 0 degrees and is less than or equal to 35 degrees so as to make the water drops condensed on the inner wall of the upper cover 24 slide along the inner wall of the upper cover 24.

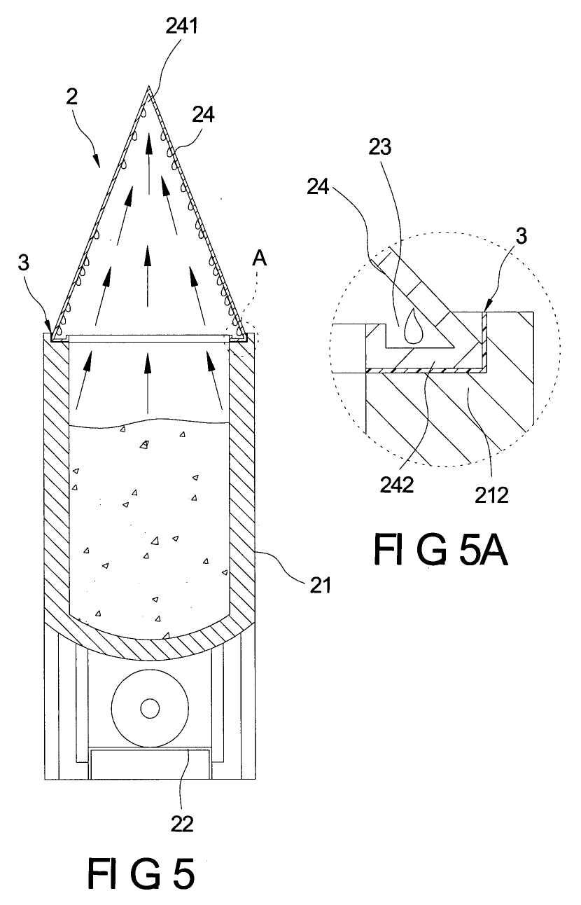

Reference is made to FIGS. 5 and 5A. The groove 23 of the dryer 2 is located at the edge 242 of the bottom of the upper cover 24. A supporting part 212 is located at the opening 211 of the dryer body 21 to carry the upper cover 24. When the upper cover 24 is covered on the dryer body 21, the groove 23 is located around the opening 211 of the dryer body 21 via the carrying part 212. The groove 23 can be integrated with the edge 242 of the bottom of the upper cover 24, or is locked or welded with the edge 242 of the bottom of the upper cover 24. Similarly, the steam rises and forms water drops on the inner wall of the upper cover 24. The water drops slide along the inner wall of the upper cover 24 and drop into the groove 23 and are collected in the groove 23. The groove exhausts the water via an exhausting water pipe 231 (as shown in FIG. 3) to prevent the water from overflowing.

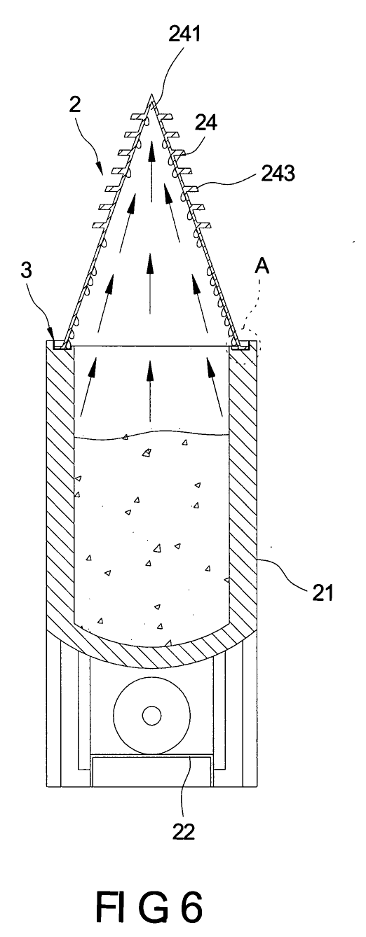

Reference is made to FIG. 6. A heat-conducting flake 243 or a cooling system (not shown in the figure) is located around the cone edge 241 of the upper cover 24 to make the cone end 241 of the upper cover 24 be cooled down rapidly. Therefore, there is a larger temperature difference (such as 10° C., the temperature of the inner part of the dryer body 21 is the boiling point of water, and the temperature of the cone end 241 of the upper cover 24 is 10° C. less than the boiling point of water) between the outer wall of the cone end 241 of the upper cover 24 and the inner part of the dryer body 21 so that the steam easily and rapidly condenses on the inner wall of the upper cover 24. The drying time is shortened and the required power is reduced.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A dryer, comprising:
a dryer body having an upward opening;
a driving device connected with the dryer body;
a control device connected with the dryer body;
a groove located around the opening of the dryer body;
an upper cover having a cone shape, wherein an angle of the cone end is larger than 0 degrees and is less than or equal to 35 degrees, the upper cover is located at the opening of the dryer body, and the edge of the bottom of the upper cover is located at the groove; and
a heat insulating element disposed in the groove and disposed between the dryer body and the upper cover for preventing heat transmitted from the dryer body to the upper cover.

2. The dryer as claimed in claim 1, wherein the groove is integrated with the dryer body into one piece, or the groove is locked or welded with the dryer body.

3. The dryer as claimed in claim 1, wherein the groove is quadrilateral-frame shaped, pentagon-frame shaped, circle-frame shaped, or irregular-frame shaped.

4. The dryer as claimed in claim 1, wherein the angle of the cone end of the upper cover is 30 degrees.

5. The dryer as claimed in claim 1, wherein the upper cover is triangle column-shaped, quadrilateral cone-shaped, pentagon cone-shaped, circle cone-shaped, or irregular-shape.

6. The dryer as claimed in claim 1, wherein the groove is integrated with the edge of bottom of the upper cover into one piece, or the groove is locked or welded with the edge of bottom of the upper cover.

7. The dryer as claimed in claim 1, wherein the groove is connected with an exhausting water pipe.

8. The dryer as claimed in claim 1, wherein a plurality of heat-conducting flakes or a cooling system is located at an outer wall of the upper cover.
